(19) United States
(12) Patent Application Publication
(10) Pub. No.: US 2014/0377649 A1
(43) Pub. Date: Dec. 25, 2014

(54) METHOD FOR PRODUCING NEGATIVE ELECTRODE FOR LITHIUM SECONDARY BATTERIES, NEGATIVE ELECTRODE FOR LITHIUM SECONDARY BATTERIES, AND LITHIUM SECONDARY BATTERY

(71) Applicant: SANYO Electric Co., Ltd., Moriguchi-shi, Osaka (JP)

(72) Inventors: Atsushi Fukui, Hyogo (JP); Taizou Sunano, Hyogo (JP)

(73) Assignee: SANYO ELECTRIC CO., LTD., Moriguchi-shi, Osaka (JP)

(21) Appl. No.: 14/368,741

(22) PCT Filed: Dec. 7, 2012
(86) PCT No.: PCT/JP2012/081748

§ 371 Date: Jun. 25, 2014

(30) Foreign Application Priority Data
Dec. 26, 2011 (JP) 2011-283933

(51) Int. Cl. H01M 4/62; H01M 10/052; H01M 4/38

(52) U.S. Cl. CPC H01M 4/623; H01M 4/386; H01M 10/052; H01M 2220/30
USPC 429/217

(57) ABSTRACT

Provided is a method for producing a negative electrode for lithium secondary batteries, the negative electrode being capable of imparting high cycle characteristics to a lithium secondary battery. A method for producing a negative electrode 11 of a lithium secondary battery 1 includes a step of obtaining a negative electrode binder-mixed liquid by mixing a derivative of a tetracarboxylic acid compound that is soluble in an aqueous solvent, a diamine compound soluble in the aqueous solvent, and a polytetrafluoroethylene resin with an average particle size of 0.1 μm to 0.5 μm in the aqueous solvent.

### TECHNICAL FIELD

The present invention relates to a method for producing a negative electrode for lithium secondary batteries, a negative electrode for lithium secondary batteries, and a lithium secondary battery.

### BACKGROUND ART

Hitherto, lithium secondary batteries have been widely used in electronic devices such as mobile phones, notebook personal computers, and PDAs. A graphite material is widely used as a negative electrode active material for such lithium secondary batteries.

In recent years, attempts have been made to use silicon-containing materials as negative electrode active materials for the purpose of increasing the energy density of lithium secondary batteries. However, in the case of using a silicon-containing material as a negative electrode active material, the volume of the negative electrode active material varies significantly when the negative electrode active material stores or releases lithium in association with the charge or discharge of a lithium secondary battery. This causes the pulverization of the negative electrode active material, the delamination of a negative electrode active material layer from a negative electrode current collector, or the like to reduce the current-collecting performance of a negative electrode, leading to a problem that charge-discharge cycle characteristics of a lithium secondary battery are deteriorated.

As a method for solving such a problem, it is conceivable that, for example, a negative electrode active material layer is impregnated with a binder with high adhesion force. Those containing a polyimide resin, a polytetrafluoroethylene resin (hereinafter referred to as a PTFE resin in some cases), or the like are known as binders with high adhesion force (refer to, for example, Patent Literature 1).

### CITATION LIST

### Patent Literature

PTL 1: Japanese Published Unexamined Patent Application No. 2011-150931

### SUMMARY OF INVENTION

### Technical Problem

Polyimide resins are sparingly soluble in water and therefore are generally used in such a manner that the polyimide resins are dissolved in an organic solvent such as N-methyl-2-pyrrolidone (NMP). On the other hand, particles of a PTFE resin are sparingly soluble in organic solvents and therefore are generally used in the form of a dispersion in which the particles are dispersed in water. In the case where a polyimide resin dissolved in an organic solvent is mixed with a PTFE dispersion in which a PTFE resin is dispersed in water, there is a problem in that primary particles of the PTFE resin are not evenly dispersed in the polyimide resin because the primary particles of the PTFE resin aggregate and precipitate. In order to solve the problem, Patent Literature 1 proposes that particles of a tetrafluoroethylene-hexafluoropropylene copolymer (hereinafter referred to as FEP in some cases) resin are added to a binder.

However, adding a component such as a FEP resin to a binder may possibly cause a problem that the mechanical strength of a negative electrode active material layer is reduced. The reduction in mechanical strength of the negative electrode active material layer may possibly reduce cycle characteristics of a lithium secondary battery.

The present invention has a principal object to provide a method for producing a negative electrode for lithium secondary batteries, the negative electrode being capable of imparting high cycle characteristics to a lithium secondary battery.

### Solution to Problem

A method for producing a negative electrode for lithium secondary batteries according to the present invention includes a step of obtaining a negative electrode binder-mixed liquid by mixing a derivative of a tetracarboxylic acid compound that is soluble in an aqueous solvent, a diamine compound soluble in the aqueous solvent, and a polytetrafluoroethylene resin with an average particle size of 0.1 μm to 0.5 μm in the aqueous solvent; a step of obtaining a negative electrode additive slurry by mixing the negative electrode binder-mixed liquid with negative electrode active material particles containing at least one of silicon and a silicon alloy; a step of forming a negative electrode additive layer on a negative electrode current collector in such a manner that the negative electrode additive slurry is applied to a surface of the negative electrode current collector and is dried; and a step of obtaining a negative electrode in such a manner that the negative electrode additive layer is heat-treated in a non-oxidizing atmosphere such that a polyimide resin is produced by the dehydrocondensation reaction of the derivative of the tetracarboxylic acid compound with the diamine compound and a negative electrode active material layer containing the negative electrode active material particles, the polytetrafluoroethylene resin, and the polyimide resin is formed on the negative electrode current collector.

Incidentally, in the present invention, the term “aqueous solvent” refers to a solvent including water. Furthermore, in the present invention, the average particle size of a PTFE resin is the cumulative volume 50% diameter obtained by measuring the particle size distribution by a laser diffraction method.

A negative electrode for lithium secondary batteries according to the present invention includes a negative electrode current collector and a negative electrode active material layer. The negative electrode active material layer is placed on the negative electrode current collector. The negative electrode active material layer contains negative electrode active material particles, a polyimide resin, and a polytetrafluoroethylene resin. The negative electrode active material particles contain at least one of silicon and a silicon alloy. The polyimide resin is one obtained by the dehydrocondensation reaction of a derivative of a tetracarboxylic acid compound that is soluble in an aqueous solvent with a diamine compound soluble in the aqueous solvent. The polytetrafluoroethylene resin has an average particle size of 0.1 μm to 0.5 μm.

A lithium secondary battery according to the present invention includes the above negative electrode, a positive electrode, a non-aqueous electrolyte, and a separator.

### Advantageous Effects of Invention

According to the present invention, a method for producing a negative electrode for lithium secondary batteries can be provided, the negative electrode being capable of imparting high cycle characteristics to a lithium secondary battery.

### BRIEF DESCRIPTION OF DRAWINGS

FIG. 1 is a schematic sectional view of a lithium secondary battery according to an embodiment of the present invention.

FIG. 2 is a schematic sectional view of a negative electrode of a lithium secondary battery according to an embodiment of the present invention.

### DESCRIPTION OF EMBODIMENTS

An example of preferred embodiments of the present invention is described below. However, the embodiments below are for exemplification only. The present invention is not limited to the embodiments.

In drawings referenced in the embodiments, members having substantially the same function are denoted by the same reference numerals. The drawings referenced in the embodiments are those schematically illustrated and therefore the dimensional ratio or the like of objects shown in the drawings may possibly be different from the dimensional ratio or the like of actual objects. The dimensional ratio or the like of objects may possibly be different between the drawings. The dimensional ratio or the like of specific objects should be judged in consideration of descriptions below.

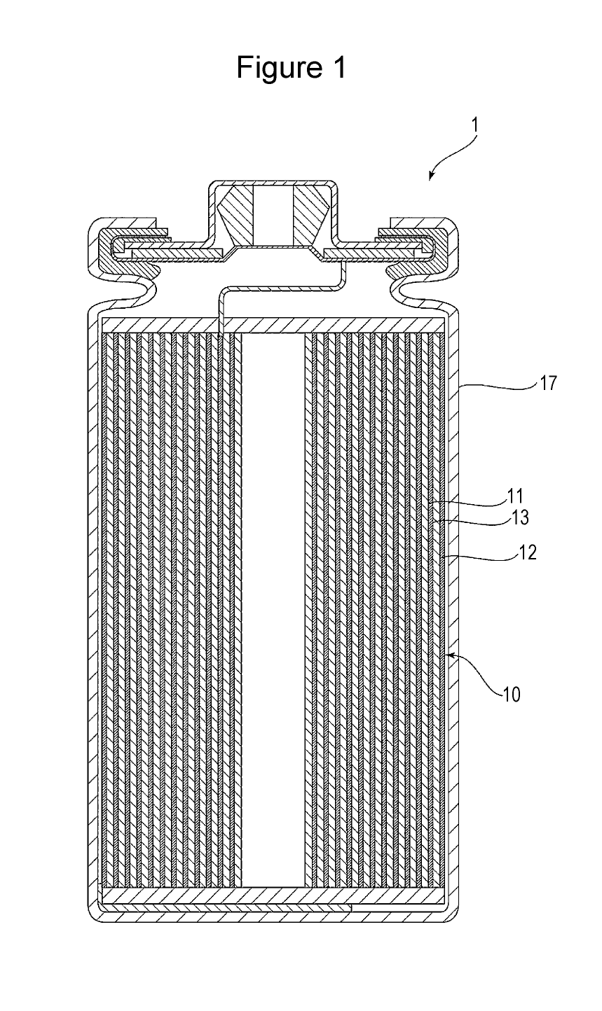

As shown in FIG. 1, a lithium secondary battery 1 includes a battery case 17. In this embodiment, the battery case 17 is cylindrical. However, in the present invention, battery cases are not limited to a cylindrical shape. The battery case 17 may be, for example, flat or prismatic.

The battery case 17 accommodates an electrode assembly impregnated with a non-aqueous electrolyte.

The non-aqueous electrolyte contains a lithium salt and a non-aqueous solvent. Examples of the lithium salt include LiXF_{y} (where X is P, As, Sb, B, Bi, Al, Ga, or In; y is 6 when X is P, As, or Sb; and y is 4 when X is B, Bi, Al, Ga, or In), lithium (perfluoroalkylsulfonyl)imide LiN(CₘF₂ₘ₊₁SO₂) (CₙF₂ₙ₊₁SO₂) (where m and n are independently an integer of 1 to 4), lithium (perfluoroalkylsulfonyl)methide LiC(CₚF₂ₚ₊₁SO₂) (C_{q}F_{2q+1}SO₂) (CᵣF₂ᵣ₊₁SO₂) (where p, q, and r are independently an integer of 1 to 4), LiCF₃SO₃, LiClO₄, Li₂B₁₀Cl₁₀, and Li₂B₁₂Cl₁₂. Among these compounds, the lithium salt is preferably LiPF₆, LiBF₄, LiN(CF₃SO₂)₂, LiN(C₂F₅SO₂)₂, LiN(CF₃SO₂)(C₄F₉SO₂), LiC(CF₃SO₂)₃, and LiC(C₂F₅SO₂)₃. The non-aqueous electrolyte may contain a type of lithium salt or several types of lithium salts.

The non-aqueous solvent in the non-aqueous electrolyte is, for example, a cyclic carbonate, a linear carbonate, a mixed solvent of the cyclic carbonate and the linear carbonate, or the like. The cyclic and linear carbonates may be fluorinated. Particular examples of the cyclic carbonate include, for example, ethylene carbonate, propylene carbonate, butylene carbonate, and vinylene carbonate. A particular example of a fluorinated cyclic carbonate is, for example, fluoroethylene carbonate. Particular examples of the linear carbonate include, for example, dimethyl carbonate, methyl ethyl carbonate, and diethyl carbonate. In particular, the mixed solvent of the cyclic carbonate and the linear carbonate is a non-aqueous solvent having low viscosity, a low melting point, and high lithium ion conductivity and is preferably used. In the mixed solvent of the cyclic carbonate and the linear carbonate, the mixing ratio (the cyclic carbonate: the linear carbonate) of the cyclic carbonate to the linear carbonate preferably ranges from 1:9 to 5:5 on a volume basis.

The non-aqueous solvent may be a mixed solvent of the cyclic carbonate and an ethereal solvent such as 1,2-dimethoxyethane or 1,2-diethoxyethane.

Furthermore, an ionic liquid can be used as the non-aqueous solvent in the non-aqueous electrolyte. Cationic and anionic species in the ionic liquid are not particularly limited. From the viewpoint of low viscosity, electrochemical stability, and hydrophobicity, for example, a pyridinium cation, an imidazolium cation, or a quaternary ammonium cation is preferably used as a cation. For example, an ionic liquid containing a fluorine-containing imide anion is preferably used as an anion.

Alternatively, the non-aqueous solvent may be a gelled polymer electrolyte prepared by impregnating a polymer electrolyte such as polyethylene oxide or polyacrylonitrile with an electrolyte solution, an inorganic solid electrolyte such as LiI or Li₃N, or the like.

The electrode assembly 10 includes a negative electrode 11, a positive electrode 12, and a separator 13 placed between the negative electrode 11 and the positive electrode 12, the negative electrode 11, the positive electrode 12, and the separator 13 being wound.

The separator 13 is not particularly limited and may be one which can reduce a short circuit due to the contact of the negative electrode 11 with the positive electrode 12 and which can achieve lithium ion conductivity by the impregnation of the non-aqueous electrolyte. The separator 13 can be formed using a porous membrane made of resin. Particular examples of the porous membrane made of resin include, for example, porous membranes made of polypropylene or polyethylene and laminates of porous membranes made of polypropylene and porous membranes made of polyethylene.

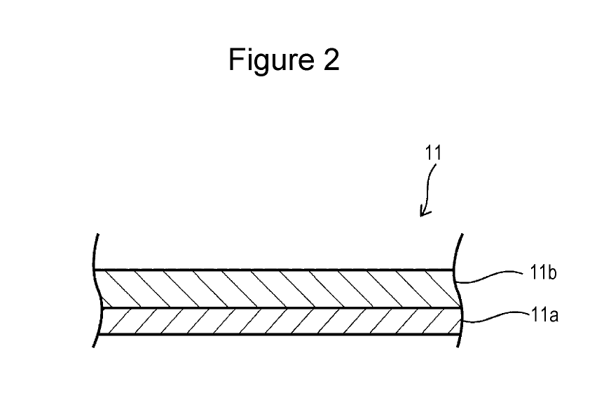

As shown in FIG. 2, the negative electrode 11 includes a negative electrode current collector 11a and a negative electrode active material layer 11b.

The negative electrode current collector 11a can be formed using, for example, foil made of metal such as Cu or an alloy containing metal such as Cu. The negative electrode current collector 11a usually has a thickness of about 10 μm to 30 μm.

The negative electrode active material layer 11b is placed on at least one surface of the negative electrode current collector 11a. The negative electrode active material layer 11b contains particles of a negative electrode active material. The negative electrode active material particles contain at least one of silicon or a silicon alloy that can reversibly store and release lithium. Particular examples of the negative electrode active material particles include polycrystalline silicon powders.

The negative electrode active material particles preferably have a median size of about 1 μm to 20 μm, more preferably about 5 μm to 15 μm, and further more preferably about 7 μm to 13 μm. Incidentally, in the present invention, the median size of the negative electrode active material particles is the cumulative volume 50% diameter obtained by measuring the particle size distribution by a laser diffraction method.

The content of at least one of silicon and the silicon alloy in the negative electrode active material layer 11b is preferably about 70% to 97% by mass, more preferably about 80% to 95% by mass, and further more preferably about 85% to 90% by mass.

The negative electrode active material layer 11b may contain a negative electrode conductive agent. The negative electrode conductive agent, which is contained in the negative electrode active material layer 11b, is graphite particles or the like. The content of the conductive agent in the negative electrode active material layer 11b is preferably about 1% to 25% by mass, more preferably about 3% to 15% by mass, and further more preferably about 4% to 10% by mass.

The thickness (the sum of both surfaces) of the negative electrode active material layer 11b is preferably about 5 μm to 100 μm, more preferably about 10 μm to 70 μm, and further more preferably about 20 μm to 50 μm. When the thickness of the negative electrode active material layer 11b is 5 μm or less, the thickness of the negative electrode active material layer is small with respect to that of the current collector and therefore the energy density of the battery may possibly be reduced. When the thickness of the negative electrode active material layer 11b is 100 μm or more, the change in thickness thereof increases during charge and therefore the current-collecting performance may possibly be reduced.

The negative electrode active material layer 11b contains a polyimide resin serving as a negative electrode binder.

The polyimide resin is one obtained by the dehydrocondensation reaction of a derivative of a tetracarboxylic acid compound that is soluble in an aqueous solvent with a diamine compound soluble in the aqueous solvent.

For the derivative of the tetracarboxylic acid compound that is soluble in the aqueous solvent, for example, 3 g or more of the derivative of the tetracarboxylic acid compound is preferably soluble in 100 g of an aqueous solvent containing 70 g of water and more preferably 5 g or more.

A particular example of the derivative of the tetracarboxylic acid compound that is soluble in the aqueous solvent is an esterified product of a monohydric alcohol and the tetracarboxylic acid compound or the dianhydride thereof.

Examples of the tetracarboxylic dianhydride include aromatic tetracarboxylic dianhydrides such as 3,3′,4,4′-benzophenonetetracarboxylic dianhydride, 3,3′,4,4′-biphenyltetracarboxylic dianhydride, 1,2,4,5-benzenetetracarboxylic 1,2,4,5-dianhydride (synonym: pyromellitic dianhydride), 3,3′,4,4′-diphenylsulfonetetracarboxylic dianhydride, 3,3′,4,4′-diphenylethertetracarboxylic dianhydride, and 3,3′,4,4′-diphenylmethanetetracarboxylic dianhydride.

Examples of the monohydric alcohol include aliphatic alcohols such as methanol, ethanol, isopropanol, butanol, ethylcellosolve, butylcellosolve, propylene glycol ethyl ether, and ethylcarbitol and compounds, such as cyclic alcohols including benzyl alcohol and cyclohexanol, having a single alcoholic OH group.

For the diamine compound soluble in the aqueous solvent, for example, 2 g or more of the diamine compound is preferably soluble in 100 g of an aqueous solvent containing 70 g of water and more preferably 4 g or more.

Examples of the diamine compound include aromatic diamines such as m-phenylenediamine, p-phenylenediamine, 3,3′-diaminobenzophenone, 4,4′-diaminobiphenyl, 4,4′-diaminodiphenylsulfone, 4,4′-diaminophenyl ether, 4,4′-diaminophenylmethane, 2,2-bis(4-(4-aminophenoxy)phenyl)propane, 1,4-bis(3-aminophenoxy)benzene, and 1,4-bis(4-aminophenoxy)benzene.

The polyimide resin preferably has a weight-average molecular weight of about 10,000 to 50,000, more preferably about 15,000 to 40,000, and further more preferably about 20,000 to 35,000. In the negative electrode active material layer 11b, when the weight-average molecular weight of the polyimide resin is less than 10,000, the adhesion may possibly be reduced. When the weight-average molecular weight thereof is more than 50,000, the electron conductivity of an electrode surface may possibly be reduced.

The polyimide resin preferably has repeating units represented by General Formula (1) below.

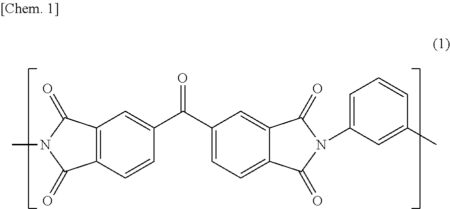

The polyimide resin, which has the repeating units represented by General Formula (1), has high mechanical strength and high adhesion to silicon and the silicon alloy and therefore is preferred.

The polyimide resin, which has the repeating units represented by General Formula (1), can be obtained by, for example, the dehydrocondensation of a derivative of benzophenonetetracarboxylic acid with m-phenylenediamine.

The content of the polyimide resin in the negative electrode active material layer 11b is preferably about 1% to 25% by mass, more preferably about 3% to 20% by mass, and further more preferably about 5% to 15% by mass.

The negative electrode active material layer 11b further contains a polytetrafluoroethylene resin (PTFE resin) serving as a negative electrode binder.

The PTFE resin has an average particle size of 0.1 μm to 0.5 μm. Since the average particle size of the PTFE resin is 0.1 μm to 0.5 μm, particles of the PTFE resin are evenly dispersed in the whole negative electrode active material layer 11b and are unevenly distributed on connections between the negative electrode active material particles and connections between the negative electrode active material particles and the negative electrode current collector 11a. The uneven distribution of the PTFE resin particles on these connections increases the adhesion strength between the negative electrode active material particles and the adhesion strength between the negative electrode current collector 11a and the negative electrode active material particles. Furthermore, the area of the PTFE resin that covers the negative electrode active material particles and a surface of the negative electrode current collector 11a can be reduced. Therefore, the reduction in electron conductivity of the negative electrode can be suppressed. When the average particle size of the PTFE resin is less than 0.1 μm or is more than 1 μm, the average particle size of the PTFE resin is excessively small or excessively large, respectively, as compared to the negative electrode active material particles. In this case, an effect due to the uneven distribution of the PTFE resin particles is small and the adhesion strength therebetween may possibly be reduced.

The content of the PTFE resin in the negative electrode active material layer 11b is preferably about 1% to 10% by mass, more preferably about 2% to 8% by mass, and further more preferably about 3% to 7% by mass.

The mass ratio (the polyimide resin: the PTFE resin) of the polyimide resin to PTFE resin in the negative electrode active material layer 11b is 90:10 to 70:30 and more preferably 85:15 to 75:25. When the mass proportion of the polyimide resin in the negative electrode active material layer 11b exceeds 90, the mass proportion of the PTFE resin is excessively small. Therefore, the effect due to the uneven distribution of the PTFE resin particles is small and the adhesion strength may possibly be reduced. When the mass proportion of the polyimide resin in the negative electrode active material layer 11b falls below 70, the mass proportion of the polyimide resin is excessively small. In this case, the adhesion of the negative electrode active material layer 11b may possibly be reduced. Furthermore, the proportion of the PTFE resin in a negative electrode binder-mixed liquid is excessively large and therefore particles of the PTFE resin aggregate in the negative electrode binder-mixed liquid. Thus, the PTFE resin particles are not evenly dispersed in the negative electrode active material layer 11b in the form of primary particles and therefore the effect due to the uneven distribution of the PTFE resin particles may possibly be small.

The PTFE resin is a low-surface tension material (the critical surface tension of the PTFE resin is about 18.5 dyne/cm). Therefore, the PTFE resin generally has low wettability to a non-aqueous electrolytic solution. Thus, the wettability of the negative electrode active material layer 11b to the non-aqueous electrolytic solution, that is, the liquid-holding capacity of the negative electrode active material layer 11b can be controlled by adjusting the content of the PTFE resin in the negative electrode active material layer 11b. This control can be accurately performed by whether fluorine atoms are contained in the non-aqueous electrolytic solution or not. When the liquid-holding capacity of the negative electrode active material layer 11b is excessively high, the liquid-holding capacity of the positive electrode 12 is relatively low. Hence, the supply of lithium ions to the positive electrode 12 is reduced and therefore charge-discharge cycle characteristics may possibly be reduced. Alternatively, when the liquid-holding capacity of the negative electrode active material layer 11b is excessively low, the supply of lithium ions to the negative electrode 11 is reduced and therefore charge-discharge cycle characteristics may possibly be reduced.

In the negative electrode 11 of the lithium secondary battery 1, the negative electrode active material layer 11b contains the polyimide resin, which is obtained by the dehydrocondensation reaction of the derivative of the tetracarboxylic acid compound that is soluble in the aqueous solvent with the diamine compound soluble in the aqueous solvent, and the polytetrafluoroethylene resin with an average particle size of 0.1 μm to 0.5 μm. This allows the negative electrode active material layer 11b to have high adhesion. Thus, even in the case where the volume of the negative electrode active material layer 11b is varied, the negative electrode current collector 11a and the negative electrode active material layer 11b are unlikely to be separated from each other. Hence, charge-discharge cycle characteristics of the lithium secondary battery 1 can be improved.

The negative electrode 11 can be produced, for example, as described below.

First, the derivative of the tetracarboxylic acid compound that is soluble in the aqueous solvent, the diamine compound soluble in the aqueous solvent, and the PTFE resin with an average particle size of 0.1 μm to 0.5 μm are mixed in the aqueous solvent, whereby the negative electrode binder-mixed liquid is obtained. In particular, first, the derivative of the tetracarboxylic acid compound that is soluble in the aqueous solvent and the diamine compound soluble in the aqueous solvent are dissolved in the aqueous solvent, whereby a mixed solution is obtained. Next, the mixed solution is mixed with a PTFE dispersion prepared by dispersing the PTFE resin with an average particle size of 0.1 μm to 0.5 μm in water, whereby the negative electrode binder-mixed liquid is obtained. In this operation, the PTFE dispersion is added dropwise thereto such that the derivative of the tetracarboxylic acid compound and the diamine compound are not precipitated. This enables the PTFE resin with an average particle size of 0.1 μm to 0.5 μm to be evenly dispersed in the negative electrode binder-mixed liquid. Since the PTFE resin with an average particle size of 0.1 μm to 0.5 μm is evenly dispersed in the negative electrode binder-mixed liquid, the PTFE resin with an average particle size of 0.1 μm to 0.5 μm can be evenly dispersed in the negative electrode active material layer 11b, which is obtained in a subsequent step, and the adhesion of the negative electrode active material layer 11b can be increased. Incidentally, the PTFE dispersion, in which the PTFE resin is dispersed in water, is one that is obtained in such a manner that a polytetrafluoroethylene monomer is used as a source material and is polymerized in water by an emulsion polymerization process such that the PTFE resin has an average particle size of about 0.1 μm to 0.5 μm. The PTFE dispersion generally contains about 2% to 10% by mass of a nonionic surfactant, such as a polyoxyethylene alkyl allyl ether, serving as a stabilizer. An anionic surfactant may possibly be contained therein instead of the nonionic surfactant.

As the derivative of the tetracarboxylic acid compound that is soluble in the aqueous solvent, the diamine compound soluble in the aqueous solvent, and the PTFE resin with an average particle size of 0.1 μm to 0.5 μm, those described above can be used. Incidentally, a solvent, other than water, contained in the aqueous solvent is preferably, for example, a polar solvent such as N-methyl-2-pyrrolidone (NMP) or dimethylacetamide (DMAc). When the aqueous solvent is a mixed solvent of water and the polar solvent, the derivative of the tetracarboxylic acid compound and the diamine compound are unlikely to be precipitated during the dropwise addition of the PTFE dispersion. Furthermore, the aggregation of primary particles of the PTFE resin can be suppressed. The polar solvent is preferably NMP.

Next, the negative electrode binder-mixed liquid is mixed with the negative electrode active material particles, which contain at least one of silicon or the silicon alloy, whereby a negative electrode additive slurry is obtained. As the negative electrode active material particles, which contain at least one of silicon or the silicon alloy, those described above can be used.

Next, the negative electrode additive slurry is applied to a surface of the negative electrode current collector 11a and is then dried, whereby a negative electrode additive layer is formed on the negative electrode current collector 11a.

Next, the negative electrode additive layer on the negative electrode current collector 11a is heat-treated in a non-oxidizing atmosphere. This heat treatment causes the dehydrocondensation reaction of the derivative of the tetracarboxylic acid with the diamine compound present in the negative electrode additive layer to produce the polyimide resin. The dehydrocondensation reaction of the derivative of the tetracarboxylic acid with the diamine compound and the progress of an imidization reaction subsequent thereto can be controlled by varying the temperature of this heat treatment. This control enables the molecular weight, structure (the degree of imidization), or the like of the polyimide resin to be controlled. When the temperature of the heat treatment performed in the non-oxidizing atmosphere exceeds the glass transition temperature (Tg) of a negative electrode binder, such as the polyimide resin or the PTFE resin, contained in the negative electrode active material layer 11b, the negative electrode binder becomes plastic during the heat treatment. Therefore, the negative electrode binder is fused at the interface between the negative electrode current collector 11a and the negative electrode active material layer 11b. Thus, the adhesion between the negative electrode current collector 11a and the negative electrode active material layer 11b is further increased. The temperature of the heat treatment preferably falls below the 5% weight loss temperature of the negative electrode binder, which is contained in the negative electrode active material layer 11b. When the temperature of the heat treatment exceeds the 5% weight loss temperature of the negative electrode binder, the negative electrode binder is thermally degraded and therefore is reduced in strength; hence, the adhesion therebetween may possibly be reduced. The melting point of the PTFE resin and the 5% weight loss temperature thereof are, for example, about 327° C. and 550° C., respectively. Thus, the temperature of the heat treatment is preferably about 330° C. to 350° C.

As described above, the negative electrode 11 can be produced such that the negative electrode active material layer 11b, which contains the negative electrode active material particles, the PTFE resin, and the polyimide resin, is placed on the negative electrode current collector 11a.

In a method for producing the negative electrode 11, the negative electrode binder-mixed liquid is obtained in such a manner that the derivative of the tetracarboxylic acid compound that is soluble in the aqueous solvent, the diamine compound soluble in the aqueous solvent, and the PTFE resin with an average particle size of 0.1 μm to 0.5 μm are mixed in the aqueous solvent. Therefore, the PTFE resin with an average particle size of 0.1 μm to 0.5 μm is evenly dispersed in the negative electrode binder-mixed liquid without adding another component (for example, an FEP resin or the like) for evenly dispersing primary particles of the PTFE resin in the negative electrode active material layer 11b, which contains the polyimide resin. Since the PTFE resin with an average particle size of 0.1 μm to 0.5 μm is evenly dispersed in the negative electrode binder-mixed liquid, the PTFE resin with an average particle size of 0.1 μm to 0.5 μm is evenly dispersed in the negative electrode active material layer 11b, which is subsequently formed. Thus, the PTFE resin can be unevenly distributed between the negative electrode active material and the negative electrode current collector 11a and the adhesion of the negative electrode active material layer 11b can be increased. The increase in adhesion of the negative electrode active material layer 11b allows high cycle characteristics to be imparted to the lithium secondary battery 1.

The positive electrode 12 includes a positive electrode current collector and a positive electrode active material layer placed on at least one surface of the positive electrode current collector. The positive electrode current collector may be made of, for example, metal such as Al or an alloy containing metal such as Al.

The positive electrode active material layer contains a positive electrode active material. The positive electrode active material layer may contain an appropriate material such as a binding agent or a conductive agent in addition to the positive electrode active material. A particular example of the binding agent that is preferably used is, for example, polyvinylidene fluoride. A particular example of the conductive agent that is preferably used is, for example, a carbon material such as graphite or acetylene black.

The type of the positive electrode active material is not particularly limited. The positive electrode active material is preferably a lithium-containing transition metal oxide. The lithium-containing transition metal oxide is, for example, a lithium composite oxide, such as lithium cobaltate, a lithium composite oxide of cobalt-nickel-manganese, a lithium composite oxide of aluminium-nickel-manganese, or a composite oxide of aluminium-nickel-cobalt, containing at least one of cobalt and manganese. The positive electrode active material may be made of one species only or two or more species.

The present invention is further described below in detail with reference to particular examples. However, the present invention is not limited to the examples and can be appropriately modified without departing from the scope thereof.

### Example 1

### Preparation of Negative Electrode

### (1) Preparation of Negative Electrode Active Material

First, fine particles of polycrystalline silicon were introduced into a fluidized bed with an internal temperature of 800° C. and monosilane (SiH₄) was fed thereto, whereby granular polycrystalline silicon was prepared. The granular polycrystalline silicon was crushed using a jet mill, followed by classification with a classifier, whereby a polycrystalline silicon powder (negative electrode active material) with a median size of about 10 μm was prepared. The median size of the obtained polycrystalline silicon powder was the cumulative volume 50% diameter obtained by measuring the particle size distribution by a laser diffraction method. The crystallite size of the polycrystalline silicon powder was 44 nm as calculated by the Scherrer equation using the full width at half maximum of the (111) peak of silicon in powder X-ray diffraction.

### (2) Preparation of Negative Electrode Binder-Mixed Liquid

A product obtained by esterifying benzophenonetetracarboxylic dianhydride with two equivalents of ethanol and m-phenylenediamine were dissolved in N-methyl-2-pyrrolidone (NMP) such that the molar ratio thereof was 1:1. Next, water was added dropwise such that the product obtained by esterifying benzophenonetetracarboxylic dianhydride with two equivalents of ethanol and m-phenylenediamine were not precipitated, followed by mixing. Next, a PTFE dispersion obtained by dispersing a PTFE resin with an average particle size (primary particle size) of 0.2 μm in water was added dropwise such that the mass ratio (the polyimide resin:the PTFE resin) of a polyimide resin (one obtained by the dehydrocondensation reaction of benzophenonetetracarboxylic dianhydride with m-phenylenediamine during subsequent heat treatment) to the PTFE resin was 80:20, followed by mixing, whereby a negative electrode binder-mixed liquid was prepared. The average particle size of the PTFE resin is the cumulative volume 50% diameter obtained by measuring the particle size distribution by a laser diffraction method.

### (3) Preparation of Negative Electrode Additive Slurry

The negative electrode active material obtained as described above, a graphite powder (an average particle size of about 3 μm and a BET specific surface area of 12.5 m²/g) serving as a negative electrode conductive agent, and the negative electrode binder-mixed liquid obtained as described above were mixed such that mass ratio (the negative electrode active material: the negative electrode conductive agent: the negative electrode binder) of the negative electrode active material to the negative electrode conductive agent to a negative electrode binder (the sum of the polyimide resin and the PTFE resin) was 88.0:3.7:8.7, whereby a negative electrode additive slurry was prepared.

### (4) Preparation of Negative Electrode Active Material Layers

A negative electrode current collector was prepared in such a manner that both surfaces of copper alloy foil (a composition of 99.7% by mass Cu, 0.2% by mass Cr, and 0.1% by mass Zr) having a thickness of 12 μm, a length of 1,000 mm, and a width of 58 mm were subjected to electrolytic copper roughening so as to have a surface roughness Ra (JIS B 0601-1994) of 0.25 μm and a mean peak spacing S (JIS B 0601-1994) of 0.85 μm. Next, the negative electrode additive slurry obtained as described above was applied to both surfaces of the negative electrode current collector at 25° C. in air so as to form the same coating pattern on the front and back surfaces. The pattern had an uncoated portion, extending from an end, having a length of 80 mm and a width of 58 mm and a coated portion having a length of 900 mm and a width of 58 mm. Next, drying was performed at 120° C. in air and rolling was performed at 25° C. in air, whereby negative electrode additive layers were formed on the surfaces of the negative electrode current collector. Furthermore, the negative electrode additive layers were heat-treated at 330° C. for 10 hours in an argon atmosphere, whereby negative electrode active material layers were formed on the surfaces of the negative electrode current collector. The amount of the negative electrode active material layers on the negative electrode current collector was 7.3 mg/cm² (the sum of both surfaces) and the thickness of the negative electrode active material layers was 45 μm (the sum of both surfaces). A negative electrode was prepared as described above. A nickel plate serving as a negative electrode current-collecting tab was connected to the uncoated portion, which was located in an end portion of the obtained negative electrode.

An experiment below was performed for the purpose of confirming the fact that the polyimide resin was produced from the product obtained by esterifying benzophenonetetracarboxylic dianhydride, which was a monomer component of the polyimide resin, with two equivalents of ethanol and m-phenylenediamine.

In the preparation of the negative electrode binder-mixed liquid, after a solvent was removed by drying one unmixed with the PTFE dispersion at 120° C. in air, the infrared (IR) absorption spectrum of one heat-treated at 330° C. for 10 hours in an argon atmosphere similarly to the heat treatment of the negative electrode as described below was measured. As a result, a peak originating from an imide bond was detected near 1,720 cm⁻¹. This confirmed that a dehydrocondensation reaction and an imidization reaction proceeded due to heat treatment to produce the polyimide resin.

Furthermore, in the preparation of the negative electrode binder-mixed liquid, the glass transition temperature (Tg) of one obtained by drying and then heat-treating one unmixed with the PTFE dispersion at 330° C. for 10 hours in an argon atmosphere was 290° C. as determined by differential scanning calorimetry (DSC).

### [Preparation of Positive Electrode]

### (1) Preparation of Positive Electrode Active Material

In a mortar, Li₂CO₃ and CoCO₂ were mixed together such that the molar ratio of Li to Co was 1:1, followed by heat treatment at 800° C. for 24 hours in an air atmosphere and then pulverization, whereby a powder of a lithium-cobalt composite oxide represented by LiCoO₂ was obtained, the powder having an average particle size of 10 μm. The obtained lithium-cobalt composite oxide powder had a BET specific surface area of 0.37 m²/g. The lithium-cobalt composite oxide was used as a positive electrode active material.

### (2) Preparation of Positive Electrode

The positive electrode active material obtained as described above, a carbon material powder serving as a positive electrode conductive agent, and polyvinylidene fluoride serving as a positive electrode binder were added to NMP such that the mass ratio (the positive electrode active material:the positive electrode conductive agent:the positive electrode binder) of the positive electrode active material to the positive electrode conductive agent to the positive electrode binder was 95:2.5:2.5, followed by kneading, whereby a positive electrode additive slurry was obtained.

The positive electrode additive slurry was applied to both surfaces of a positive electrode current collector including aluminium foil (an aluminium 1085 material) having a thickness of 15 μm, a length of 870 mm, and a width of 56.5 mm at 25° C. in air so as to form the same coating pattern on the front and back surfaces, followed by drying at 120° C. in air and then rolling at 25° C. in air. The pattern had an uncoated portion, extending from an end, having a length of 40 mm and a width of 56.5 mm and a coated portion having a length of 830 mm and a width of 56.5 mm. The amount of positive electrode active material layers on the negative electrode current collector and the thickness of the negative electrode active material layers were 55 mg/cm² (the sum of both surfaces) and 147 μm (the sum of both surfaces), respectively, in a portion where the positive electrode active material layers were placed on both surfaces. A positive electrode was prepared as described above. An aluminium plate serving as a positive electrode current-collecting tab was connected to the uncoated portion, which was located in an end portion of the positive electrode.

### [Preparation of Non-Aqueous Electrolytic Solution]

In an argon atmosphere, 1 mol/liter of lithium hexafluorophosphate (LiPF₆) was dissolved in a solvent obtained by mixing fluoroethylene carbonate (FEC) with methyl ethyl carbonate (MEC) at a volume ratio of 2:8. Next, 0.4 mass percent of a carbon dioxide gas was dissolved in the obtained solution, whereby a non-aqueous electrolytic solution was prepared.

### [Preparation of Electrode Assembly]

The following members were used to prepare an electrode assembly: a sheet of the positive electrode obtained as described above; a sheet of the negative electrode obtained as described above; and two separators each including a microporous membrane, made of polyethylene, having a thickness of 14 μm, a length of 1,060 mm, a width of 60.5 mm, a puncture strength of 340 g, and a porosity of 49%. The positive electrode and the negative electrode were placed opposite to each other with the separators therebetween and were spirally wound around a cylindrical core such that the positive electrode tab was located innermost and the negative electrode tab was located outermost. Next, the core was removed, whereby the electrode assembly was prepared so as to have a diameter of 17.1 mm and a height of 60.5 mm and so as to be cylindrical (spiral) as shown in FIG. 1.

### [Preparation of Battery]

The cylindrical electrode assembly and non-aqueous electrolytic solution obtained as described above were provided in a cylindrical enclosure made of SUS at 25° C. in a 1 atm CO₂ atmosphere, whereby a cylindrical battery was prepared. The cylindrical battery is composed of a cylindrical metal can having an opening located at the top; the electrode assembly, which includes the positive and negative electrodes placed opposite to each other with the separators therebetween and spirally wound; the non-aqueous electrolytic solution, which is contained in the electrode assembly; a sealing lid sealing the opening of the metal can; and the like. In the cylindrical battery, the sealing lid serves as a positive electrode terminal and the metal can serves as a negative electrode terminal. A positive electrode current-collecting tab attached to the upper surface of the electrode assembly is connected to the sealing lid and a negative electrode current-collecting tab attached to the lower surface thereof is connected to the metal can. The upper surface and lower surface of the electrode assembly are covered by an upper insulating plate and lower insulating plate, respectively, for insulating the electrode assembly and the metal can. The sealing lid is fixed to the opening of the metal can with an insulating packing by swaging. As described above, the cylindrical battery has a structure enabling charge and discharge as a secondary battery. The cylindrical battery obtained as described above is referred to as Battery A1.

### Comparative Example 1

Battery B1 was prepared in substantially the same manner as that described in Example 1 except that no water was mixed with a solution of an esterified product of benzophenonetetracarboxylic dianhydride and m-phenylenediamine in NMP in the preparation of the negative electrode binder-mixed liquid of Battery A1 in Example 1.

### Comparative Example 2

A PTFE resin powder with an average particle size (secondary particle size) of 30 μm was obtained by coagulating the PTFE dispersion used in the preparation of the negative electrode binder-mixed liquid of Battery A1. Next, Battery B2 was prepared in substantially the same manner as that described in Example 1 except that the PTFE resin powder obtained in Comparative Example 2 was used instead of the PTFE dispersion with an average particle size (primary particle size) of 0.2 μm in the preparation of the negative electrode binder-mixed liquid of Battery A1.

### Comparative Example 3

A PTFE resin powder with an average particle size (secondary particle size) of 5 μm was obtained by coagulating the PTFE dispersion used in the preparation of the negative electrode binder-mixed liquid of Battery A1. Next, Battery B3 was prepared in substantially the same manner as that described in Example 1 except that the PTFE resin powder obtained in Comparative Example 3 was used instead of the PTFE dispersion with an average particle size (primary particle size) of 0.2 μm in the preparation of the negative electrode binder-mixed liquid of Battery A1.

### Comparative Example 4

Battery B4 was prepared in substantially the same manner as that described in Example 1 except that an NMP solution (a mass ratio of 1:1) of one obtained by esterifying benzophenonetetracarboxylic dianhydride with two equivalents of ethanol and m-phenylenediamine was mixed with the PTFE dispersion used in Example 1 in equal amounts on a solid basis instead of the PTFE dispersion in the preparation of the negative electrode binder-mixed liquid of Battery A1.

### Example 2

Battery A2 was prepared in substantially the same manner as that described in Example 1 except that the mass ratio of a polyimide resin (one obtained by the dehydrocondensation reaction of an esterified product of benzophenonetetracarboxylic dianhydride with m-phenylenediamine during subsequent heat treatment) to a PTFE resin was adjusted to 90:10 in the preparation of the negative electrode binder-mixed liquid of Battery A1.

### Example 3

Battery A3 was prepared in substantially the same manner as that described in Example 1 except that the mass ratio of a polyimide resin (one obtained by the dehydrocondensation reaction of an esterified product of benzophenonetetracarboxylic dianhydride with m-phenylenediamine during subsequent heat treatment) to a PTFE resin was adjusted to 70:30 in the preparation of the negative electrode binder-mixed liquid of Battery A1.

### Example 4

Battery A4 was prepared in substantially the same manner as that described in Example 1 except that the mass ratio of a polyimide resin (one obtained by the dehydrocondensation reaction of an esterified product of benzophenonetetracarboxylic dianhydride with m-phenylenediamine during subsequent heat treatment) to a PTFE resin was adjusted to 65:35 in the preparation of the negative electrode binder-mixed liquid of Battery A1.

### Example 5

Battery A5 was prepared in substantially the same manner as that described in Example 1 except that a PTFE dispersion obtained by dispersing a PTFE resin with an average particle size of 0.4 μm in water was used in the preparation of the negative electrode binder-mixed liquid of Battery A1.

### Example 6

Battery A6 was prepared in substantially the same manner as that described in Example 1 except that the heat treatment temperature of a negative electrode additive layer was adjusted to 300° C. in the preparation of the negative electrode of Battery A1.

### Example 7

Battery A7 was prepared in substantially the same manner as that described in Example 1 except that the heat treatment temperature of a negative electrode additive layer was adjusted to 350° C. in the preparation of the negative electrode of Battery A1.

### Example 8

Battery A8 was prepared in substantially the same manner as that described in Example 1 except that the heat treatment temperature of a negative electrode additive layer was adjusted to 400° C. in the preparation of the negative electrode of Battery A1.

### [Evaluation of Charge-Discharge Cycle Characteristics]

Batteries A1 to A8 and B1 to B4 obtained as described above were evaluated for charge-discharge cycle characteristics under charge-discharge cycle conditions below.

### (Charge-Discharge Cycle Conditions)

Charge conditions in first cycle: After constant-current charge was performed at a current of 170 mA for 4 hours, constant-current charge was performed at a current of 680 mA until the voltage of each battery reached 4.25 V and constant-voltage charge was further performed at a voltage of 4.25 V until the current reached 170 mA.

Discharge conditions in first cycle: Constant-current discharge was performed at a current of 680 mA until the battery voltage reached 3.1 V.

Charge conditions in second cycle and subsequent cycles: Constant-current charge was performed at a current of 1,700 mA until the battery voltage reached 4.25 V and constant-voltage charge was further performed at a voltage of 4.25 V until the current reached 60 mA.

Discharge conditions in second cycle and subsequent cycles: Constant-current discharge was performed at a current of 1,700 mA until the battery voltage reached 3.1 V.

The initial charge-discharge efficiency and the number of cycles were determined by calculation methods below.

Initial charge-discharge efficiency: discharge capacity in first cycle/charge capacity in first cycle×100

Number of cycles: the number of cycles when the capacity retention with respect to the discharge capacity in the second cycle reached 80%.

The initial charge-discharge efficiency of Batteries A1 to A8 and B1 to B4 and the number of cycles are shown in Table 1.

TABLE 1

| | | Negative electrode additive slurry | | | | | | |
|---|---|---|---|---|---|---|---|---|
| | | | PTFE | | | | | |
| | | | | | Proportion of | | Charge-discharge | |
| | | | | | polyimide resin | | cycle characteristics | |
| | | Solvent | | | and PTFE resin | | Initial charge- | |
| | | unmixed with | | Average | with respect to | Heat treatment | discharge | Number of |
| | | PTFE | | particle size | total (mass | temperature | efficiency | cycles |
| | | dispersion | State | (μm) | percent) | (° C.) | (%) | (times) |
| Example 1 | Battery A1 | Water + NMP | Dispersion | 0.2 | 20 | 330 | 81 | 190 |
| Comparative | Battery B1 | NMP | Dispersion | 0.2 | 20 | 330 | — | — |
| Example 1 | | | | | | | | |
| Comparative | Battery B2 | Water + NMP | Powder | 30 | 20 | 330 | — | — |
| Example 2 | | | | | | | | |
| Comparative | Battery B3 | Water + NMP | Powder | 5 | 20 | 330 | 76 | 105 |
| Example 3 | | | | | | | | |
| Comparative | Battery B4 | Water + NMP | — | — | — | 330 | 77 | 130 |
| Example 4 | | | | | | | | |
| Example 2 | Battery A2 | Water + NMP | Dispersion | 0.2 | 10 | 330 | 80 | 185 |
| Example 3 | Battery A3 | Water + NMP | Dispersion | 0.2 | 30 | 330 | 80 | 180 |
| Example 4 | Battery A4 | Water + NMP | Dispersion | 0.2 | 35 | 330 | 79 | 170 |
| Example 5 | Battery A5 | Water + NMP | Dispersion | 0.4 | 20 | 330 | 81 | 185 |
| Example 6 | Battery A6 | Water + NMP | Dispersion | 0.2 | 20 | 300 | 80 | 175 |
| Example 7 | Battery A7 | Water + NMP | Dispersion | 0.2 | 20 | 350 | 81 | 190 |
| Example 8 | Battery A8 | Water + NMP | Dispersion | 0.2 | 20 | 400 | 79 | 170 |

From comparisons between the examples and the comparative examples, it is clear that Batteries A1 to A8, in which a mixture of the polyimide resin and the PTFE resin with an average particle size of 0.1 μm to 0.5 μm is used as a negative electrode binder, exhibit more excellent charge-discharge cycle characteristics as compared to Batteries B2 and B3, in which the average particle size of a PTFE resin is outside this range, and Battery B4, which contain no PTFE resin.

Incidentally, in Battery B1 of Comparative Example 1, a PTFE resin aggregated during the preparation of a negative electrode additive slurry and therefore a negative electrode active material layer was not capable of being evenly formed on a negative electrode current collector. In addition, there were spots uncoated with the negative electrode active material layer on the negative electrode current collector and therefore charge-discharge cycle characteristics of Battery B1 were not capable of being evaluated.

In Battery B2 of Comparative Example 2, the average particle size of the PTFE resin used in the preparation of the negative electrode additive slurry was large and therefore a negative electrode active material layer was not capable of being evenly formed on a negative electrode current collector. In addition, there were spots uncoated with the negative electrode active material layer on the negative electrode current collector and therefore charge-discharge cycle characteristics of Battery B2 were not capable of being evaluated.

### REFERENCE SIGNS LIST

1 Lithium secondary battery
10 Electrode assembly
11 Negative electrode
11a Negative electrode current collector
11b Negative electrode active material layer
12 Positive electrode
13 Separator
17 Battery case

1.-11. (canceled)

12. A negative electrode for lithium secondary batteries, comprising:
a negative electrode current collector; and
a negative electrode active material layer which is placed on the negative electrode current collector and which contains negative electrode active material particles containing at least one of silicon and a silicon alloy, a polyimide resin obtained by the dehydrocondensation reaction of a derivative of a tetracarboxylic acid compound that is soluble in an aqueous solvent with a diamine compound soluble in the aqueous solvent, and a polytetrafluoroethylene resin with an average particle size of 0.1 μm to 0.5 μm.

13. The negative electrode for the lithium secondary batteries according to claim 12, wherein the mass ratio (the polyimide resin: the PTFE resin) of the polyimide resin to PTFE resin in the negative electrode active material layer is 90:10 to 70:30.

14. The negative electrode for the lithium secondary batteries according to claim 12, wherein the polyimide resin has repeating units represented by the following general formula (1):

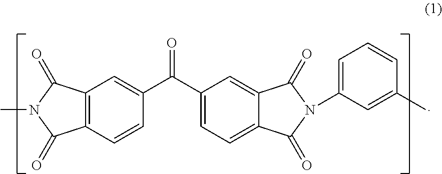

15. The negative electrode for the lithium secondary batteries according to claim 13, wherein the polyimide resin has repeating units represented by the following general formula (1):

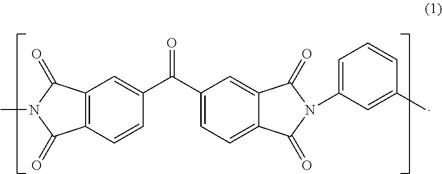

16. The negative electrode for the lithium secondary batteries according to claim 12, wherein the polyimide resin has a weight-average molecular weight of 10,000 to 50,000.

17. The negative electrode for the lithium secondary batteries according to claim 13, wherein the polyimide resin has a weight-average molecular weight of 10,000 to 50,000.

18. The negative electrode for the lithium secondary batteries according to claim 14, wherein the polyimide resin has a weight-average molecular weight of 10,000 to 50,000.

19. The negative electrode for the lithium secondary batteries according to claim 15, wherein the polyimide resin has a weight-average molecular weight of 10,000 to 50,000.

20. The negative electrode for the lithium secondary batteries according to claim 12, wherein the derivative of the tetracarboxylic acid compound that is soluble in the aqueous solvent includes an esterified product of at least one of 3,3′,4,4′-benzophenonetetracarboxylic dianhydride, 3,3′,4,4′-biphenyltetracarboxylic dianhydride, 1,2,4,5-benzenetetracarboxylic 1,2,4,5-dianhydride, 3,3′,4,4′-diphenylsulfonetetracarboxylic dianhydride, 3,3′,4,4′-diphenylethertetracarboxylic dianhydride, and 3,3′,4,4′-diphenylmethanetetracarboxylic dianhydride and at least one of methanol, ethanol, isopropanol, butanol, ethylcellosolve, butylcellosolve, propylene glycol ethyl ether, ethylcarbitol, benzyl alcohol, and cyclohexanol and the diamine compound soluble in the aqueous solvent includes at least one of m-phenylenediamine, p-phenylenediamine, 3,3′-diaminobenzophenone, 4,4′-diaminobiphenyl, 4,4′-diaminodiphenylsulfone, 4,4′-diaminophenyl ether, 4,4′-diaminophenylmethane, 2,2-bis(4-(4-aminophenoxy)phenyl)propane, 1,4-bis(3-aminophenoxy)benzene, and 1,4-bis(4-aminophenoxy)benzene.

21. The negative electrode for the lithium secondary batteries according to claim 13, wherein the derivative of the tetracarboxylic acid compound that is soluble in the aqueous solvent includes an esterified product of at least one of 3,3′,4,4′-benzophenonetetracarboxylic dianhydride, 3,3′,4,4′-biphenyltetracarboxylic dianhydride, 1,2,4,5-benzenetetracarboxylic 1,2,4,5-dianhydride, 3,3′,4,4′-diphenylsulfonetetracarboxylic dianhydride, 3,3′,4,4′-diphenylethertetracarboxylic dianhydride, and 3,3′,4,4′-diphenylmethanetetracarboxylic dianhydride and at least one of methanol, ethanol, isopropanol, butanol, ethylcellosolve, butylcellosolve, propylene glycol ethyl ether, ethylcarbitol, benzyl alcohol, and cyclohexanol and the diamine compound soluble in the aqueous solvent includes at least one of m-phenylenediamine, p-phenylenediamine, 3,3′-diaminobenzophenone, 4,4′-diaminobiphenyl, 4,4′-diaminodiphenylsulfone, 4,4′-diaminophenyl ether, 4,4′-diaminophenylmethane, 2,2-bis(4-(4-aminophenoxy)phenyl)propane, 1,4-bis(3-aminophenoxy)benzene, and 1,4-bis(4-aminophenoxy)benzene.

22. The negative electrode for the lithium secondary batteries according to claim 14, wherein the derivative of the tetracarboxylic acid compound that is soluble in the aqueous solvent includes an esterified product of at least one of 3,3′,4,4′-benzophenonetetracarboxylic dianhydride, 3,3′,4,4′-biphenyltetracarboxylic dianhydride, 1,2,4,5-benzenetetracarboxylic 1,2,4,5-dianhydride, 3,3′,4,4′-diphenylsulfonetetracarboxylic dianhydride, 3,3′,4,4′-diphenylethertetracarboxylic dianhydride, and 3,3′,4,4′-diphenylmethanetetracarboxylic dianhydride and at least one of methanol, ethanol, isopropanol, butanol, ethylcellosolve, butylcellosolve, propylene glycol ethyl ether, ethylcarbitol, benzyl alcohol, and cyclohexanol and the diamine compound soluble in the aqueous solvent includes at least one of m-phenylenediamine, p-phenylenediamine, 3,3′-diaminobenzophenone, 4,4′-diaminobiphenyl, 4,4′-diaminodiphenylsulfone, 4,4′-diaminophenyl ether, 4,4′-diaminophenylmethane, 2,2-bis(4-(4-aminophenoxy)phenyl)propane, 1,4-bis(3-aminophenoxy)benzene, and 1,4-bis(4-aminophenoxy)benzene.

23. The negative electrode for the lithium secondary batteries according to claim 15, wherein the derivative of the tetracarboxylic acid compound that is soluble in the aqueous solvent includes an esterified product of at least one of 3,3′,4,4′-benzophenonetetracarboxylic dianhydride, 3,3′,4,4′-biphenyltetracarboxylic dianhydride, 1,2,4,5-benzenetetracarboxylic 1,2,4,5-dianhydride, 3,3′,4,4′-diphenylsulfonetetracarboxylic dianhydride, 3,3′,4,4′-diphenylethertetracarboxylic dianhydride, and 3,3′,4,4′-diphenylmethanetetracarboxylic dianhydride and at least one of methanol, ethanol, isopropanol, butanol, ethylcellosolve, butylcellosolve, propylene glycol ethyl ether, ethylcarbitol, benzyl alcohol, and cyclohexanol and the diamine compound soluble in the aqueous solvent includes at least one of m-phenylenediamine, p-phenylenediamine, 3,3′-diaminobenzophenone, 4,4′-diaminobiphenyl, 4,4′-diaminodiphenylsulfone, 4,4′-diaminophenyl ether, 4,4′-diaminophenylmethane, 2,2-bis(4-(4-aminophenoxy)phenyl)propane, 1,4-bis(3-aminophenoxy)benzene, and 1,4-bis(4-aminophenoxy)benzene.

24. The negative electrode for the lithium secondary batteries according claim 16, wherein the derivative of the tetracarboxylic acid compound that is soluble in the aqueous solvent includes an esterified product of at least one of 3,3′,4,4′-benzophenonetetracarboxylic dianhydride, 3,3′,4,4′-biphenyltetracarboxylic dianhydride, 1,2,4,5-benzenetetracarboxylic 1,2,4,5-dianhydride, 3,3′,4,4′-diphenylsulfonetetracarboxylic dianhydride, 3,3′,4,4′-diphenylethertetracarboxylic dianhydride, and 3,3′,4,4′-diphenylmethanetetracarboxylic dianhydride and at least one of methanol, ethanol, isopropanol, butanol, ethylcellosolve, butylcellosolve, propylene glycol ethyl ether, ethylcarbitol, benzyl alcohol, and cyclohexanol and the diamine compound soluble in the aqueous solvent includes at least one of m-phenylenediamine, p-phenylenediamine, 3,3′-diaminobenzophenone, 4,4′-diaminobiphenyl, 4,4′-diaminodiphenylsulfone, 4,4′-diaminophenyl ether, 4,4′-diaminophenylmethane, 2,2-bis(4-(4-aminophenoxy)phenyl)propane, 1,4-bis(3-aminophenoxy)benzene, and 1,4-bis(4-aminophenoxy)benzene.

25. The negative electrode for the lithium secondary batteries according to claim 17, wherein the derivative of the tetracarboxylic acid compound that is soluble in the aqueous solvent includes an esterified product of at least one of 3,3′,4,4′-benzophenonetetracarboxylic dianhydride, 3,3′,4,4′-biphenyltetracarboxylic dianhydride, 1,2,4,5-benzenetetracarboxylic 1,2,4,5-dianhydride, 3,3′,4,4′-diphenylsulfonetetracarboxylic dianhydride, 3,3′,4,4′-diphenylethertetracarboxylic dianhydride, and 3,3′,4,4′-diphenylmethanetetracarboxylic dianhydride and at least one of methanol, ethanol, isopropanol, butanol, ethylcellosolve, butylcellosolve, propylene glycol ethyl ether, ethylcarbitol, benzyl alcohol, and cyclohexanol and the diamine compound soluble in the aqueous solvent includes at least one of m-phenylenediamine, p-phenylenediamine, 3,3′-diaminobenzophenone, 4,4′-diaminobiphenyl, 4,4′-diaminodiphenylsulfone, 4,4′-diaminophenyl ether, 4,4′-diaminophenylmethane, 2,2-bis(4-(4-aminophenoxy)phenyl)propane, 1,4-bis(3-aminophenoxy)benzene, and 1,4-bis(4-aminophenoxy)benzene.

26. The negative electrode for the lithium secondary batteries according to claim 18, wherein the derivative of the tetracarboxylic acid compound that is soluble in the aqueous solvent includes an esterified product of at least one of 3,3′,4,4′-benzophenonetetracarboxylic dianhydride, 3,3′,4,4′-biphenyltetracarboxylic dianhydride, 1,2,4,5-benzenetetracarboxylic 1,2,4,5-dianhydride, 3,3′,4,4′-diphenylsulfonetetracarboxylic dianhydride, 3,3′,4,4′-diphenylethertetracarboxylic dianhydride, and 3,3′,4,4′-diphenylmethanetetracarboxylic dianhydride and at least one of methanol, ethanol, isopropanol, butanol, ethylcellosolve, butylcellosolve, propylene glycol ethyl ether, ethylcarbitol, benzyl alcohol, and cyclohexanol and the diamine compound soluble in the aqueous solvent includes at least one of m-phenylenediamine, p-phenylenediamine, 3,3′-diaminobenzophenone, 4,4′-diaminobiphenyl, 4,4′-diaminodiphenylsulfone, 4,4′-diaminophenyl ether, 4,4′-diaminophenylmethane, 2,2-bis(4-(4-aminophenoxy)phenyl)propane, 1,4-bis(3-aminophenoxy)benzene, and 1,4-bis(4-aminophenoxy)benzene.

27. The negative electrode for the lithium secondary batteries according to claim 19, wherein the derivative of the tetracarboxylic acid compound that is soluble in the aqueous solvent includes an esterified product of at least one of 3,3′,4,4′-benzophenonetetracarboxylic dianhydride, 3,3′,4,4′-biphenyltetracarboxylic dianhydride, 1,2,4,5-benzenetetracarboxylic 1,2,4,5-dianhydride, 3,3′,4,4′-diphenylsulfonetetracarboxylic dianhydride, 3,3′,4,4′-diphenylethertetracarboxylic dianhydride, and 3,3′,4,4′-diphenylmethanetetracarboxylic dianhydride and at least one of methanol, ethanol, isopropanol, butanol, ethylcellosolve, butylcellosolve, propylene glycol ethyl ether, ethylcarbitol, benzyl alcohol, and cyclohexanol and the diamine compound soluble in the aqueous solvent includes at least one of m-phenylenediamine, p-phenylenediamine, 3,3′-diaminobenzophenone, 4,4′-diaminobiphenyl, 4,4′-diaminodiphenylsulfone, 4,4′-diaminophenyl ether, 4,4′-diaminophenylmethane, 2,2-bis(4-(4-aminophenoxy)phenyl)propane, 1,4-bis(3-aminophenoxy)benzene, and 1,4-bis(4-aminophenoxy)benzene.

28. A lithium secondary battery comprising the negative electrode according to claim 12, a positive electrode, a non-aqueous electrolyte, and a separator.
